(19) United States
(12) Patent Application Publication
(10) Pub. No.: US 2008/0032152 A1
(43) Pub. Date: Feb. 7, 2008

(54) Use of laser shock processing in oil & gas and petrochemical applications

(76) Inventors: Glen A. Vaughn, Ozark, MO (US); Narasimha-Rao Venkata Bangaru, Pittstown, NJ (US); Jayoung Koo, Somerset, NJ (US); Raghavan Ayer, Bernards Township, NJ (US); Danny L. Beeson, Houston, TX (US); Neeraj S. Thirumalai, Phillipsburg, NJ (US); David A. Baker, Bellaire, TX (US); David A. Norman, Houston, TX (US)

Correspondence Address: ExxonMobil Research and Engineering Company, P.O. Box 900, Annandale, NJ, 08801-0900, US

(21) Appl. No.: 11/499,800

(22) Filed: Aug. 4, 2006

(51) Int. Cl. B32B 15/00

(52) U.S. Cl. 428/615

(57) ABSTRACT

The use of laser shock processing in oil & gas and/or petrochemical applications is provided by the present invention. The use includes subjecting friction stir weldments, fusion weldments, and other critical regions of ferrous and non-ferrous alloy components used in oil & gas and petrochemical applications to laser shock processing to create residual compressive stresses near the surface of the treated area. The residual compressive forces in the ferrous or non-ferrous components improve properties including, inter alia, is surface strength, fatigue life, surface hardness, stress corrosion resistance, fatigue resistance, and environmental cracking resistance. Laser shock processing finds particular application in high strength pipelines, steel catenary risers, top tension risers, threaded components, liquefied natural gas containers, pressurized liquefied natural gas containers, deep water oil drill strings, riser/casing joints, and well-head equipment.

### FIELD OF THE INVENTION

The present invention relates generally to the field of laser shock peening and processing. More specifically, the present invention relates to the application of laser shock processing to improve fatigue life of parts and structures used in the oil and gas and petrochemical industries. Still more specifically, the present invention relates to the application of laser shock processing of welds, weld repairs and treatment of metal parts, particularly but not exclusively, ferrous and non-ferrous metal parts, to provide distinguished properties such as surface strength, fatigue, toughness, surface hardness, stress corrosion resistance, environmental cracking resistance and the like.

### BACKGROUND OF THE INVENTION

For convenience, various welding and materials terms used in this specification are defined in the Glossary of Terms below.

### GLOSSARY OF TERMS

CRA: Corrosion resistant alloys.

HAZ: Heat-affected-zone.

Heat-affected-zone: Base metal that is adjacent to the weld fusion line and that was affected by the heat of welding.

Toughness: Resistance to fracture initiation.

Fatigue: Failure under cyclic loading.

Fretting fatigue: Fretting involves contact between surfaces undergoing small cyclic relative tangential motion. Fretting fatigue resistance is resistance to fracture in a notched metal parts or metal parts with holes.

Strength: Ability to bear load without deformation.

Surface hardness: The resistance of a surface to deformation by surface indentation.

FSW: Friction stir welding.

Friction Stir Welding: A solid state joining process for creating a welded joint between two work pieces in which the heat for joining the metal work pieces is generated by plunging a rotating pin of a tool between the work pieces.

FSP: Friction stir processing.

Friction stir processing: The method of processing and conditioning the surface of a structure by pressing a FSW tool against the surface with partially plunging a pin into the structure.

Laser shock peening or processing: Using a laser to generate shock waves at the surface of a metal part either to produce compressive stresses and/or to reduce tensile stresses near the surface to improve the fatigue life, stress corrosion cracking, and other properties of the metal part.

LSP: Laser shock peening or processing.

Shot peening: Bombarding metal parts with tiny metal or ceramic beads to reduce compressive residual stresses near the surface to improve the fatigue life of the metal part.

SCR: Steel catenary riser.

TTR: Top tension riser.

Weld joint: A welded joint including the fused or thermo-mechanically altered metal and the base metal in the “near vicinity” of, but beyond the fused metal. The portion of the base metal that is considered within the “near vicinity” of the fused metal varies depending on factors known to those in the welding art.

Weldment: An assembly of component parts joined by welding.

Weldability: The feasibility of welding a particular metal or alloy. A number of factors affect weldability including chemistry, surface finish, heat-treating tendencies and the like.

Carbon equivalent: A parameter used to define weldability of steels and expressed by the formula CE=C+Mn/6+(Cr+Mo+V)/5+(Ni+Cu)/15 where all units are in weight percent.

Hydrogen cracking: Cracking that occurs in the weld subsequent to welding.

Stress corrosion cracking: Cracking induced from the combined influence of tensile stress and a corrosive environment.

TMAZ: Thermo-mechanically affected zone.

Thermo-mechanically affected zone: Region of the joint that has experienced both temperature cycling and plastic deformation.

TMAZ-HZ: The hardest region of a FSW joint.

The joining of metal parts such as pipes and tubes to form pipelines for oil, gas and geothermal wells and the like is largely performed by conventional arc or fusion welding. In such a process the larger the pipe diameter, or the thicker the wall of the pipe, the slower the welding becomes. For offshore pipelines, it is important that the welding be as economic as possible because of the substantial costs associated with the laybarge. Also, in welding pipes for offshore pipelines, there is the problem of bending stresses that results from the completed pipe hanging off the stem of the laybarge. In addition, conventional fusion welded joints suffer from other attributes which degrade the mechanical integrity of the joints. Examples of such attributes are residual tensile stresses, hydrogen cracking, environmental cracking, lack of fusion defects and low toughness.

In the case of high carbon content steels, such as casing steels that have a CE equal to or greater than 0.48, current welding practice requires preheating the work pieces to 100-400° C. and forming the weld with low hydrogen electrodes to minimize the formation of a hard HAZ which is susceptible to cracking. Because of the difficulties associated with such a welding technique, often high carbon steel work pieces are mechanically joined instead using various types of couplings.

As should be appreciated from the foregoing, conventional fusion welding is prone to crack initiation that originates typically in the HAZ. In the case of the petrochemical industry where thousands of miles of pipes are installed each year to transport gas, oil and fluids, the costs for repairs are significant. Hard and low toughness regions weldment, especially the HAZ, are also prone to develop cracks in service particularly when the welded component is used in service or an aggressive process environment. It is essential that these cracks are repaired before they grow to a critical dimension when they can propagate catastrophically.

U.S. Patent Application No. 60/763,101 to Bangaru et al. discloses a novel method for welding and repairing cracks in metal parts by subjecting the metal parts to be welded to friction stir welding and the cracks to be repaired to friction stir processing. This method for rapidly welding high carbon steels minimizes grain coarsening in the HAZ and weldment cracking in the absence of an open flame as is utilized in conventional welding techniques. Friction stir welding and friction stir processing are conducted under conditions sufficient to provide a weld joint or crack repair having a preselected property or set of properties based upon the intended use of the weldment. U.S. Patent Application No. 60/763,101 is incorporated herein by reference in its entirety.

In addition, fusion welding of high strength pipeline steels and other ferrous components used in the oil & gas and petrochemical industry invariably introduces residual tensile stresses and softening in a narrow zone in the heat-affected-zone. These factors degrade both the toughness and the fatigue resistance of the welded joints because residual tensile stresses increase the propensity for surface-initiated cracks. The welded joints in steels and corrosion resistant alloys are also susceptible to environmental cracking due to residual tensile stresses in corrosive environments. In off shore oil drilling platforms, conventional welding of steel catenary risers (SCRs) and top tension risers (TTRs) result in high tensile residual stresses. These residual tensile stresses necessitate an increase in section thickness and/or a higher grade material to be qualified for the service to ensure adequate fatigue life in these components. Elimination of tensile residual stresses in SCRs and TTRs and structures used to produce and transport gas, oil and fluids would decrease the size of the components without sacrificing fatigue life and reduce the cost of the offshore structure. In one particular example, liquefied natural gas (LNG) and pressurized liquefied natural gas (PLNG) containers also include high integrity weldments that have residual tensile stresses that negatively affect the fatigue resistance and toughness in the weld areas.

Hence, there is a need for a new method for treating steels in the weld area formed by conventional and non-conventional welding methods as well as other critical regions of components used in the oil, gas and petrochemical industry for transporting gas, oil and other fluids, to achieve components with superior properties and performance.

### SUMMARY OF THE INVENTION

According to the present disclosure, an advantageous method of treating ferrous or non-ferrous alloy components comprises the steps of providing an opaque overlay on said component and a transparent overlay on top of said opaque overlay to form a coated component, laser shock processing said coated component to produce a coated and treated component having at least one laser shock processed component region having compressive residual stress, removing said opaque overlay and said transparent overlay from said coated and treated component to form a treated component, and employing said treated component in oil/gas and/or petrochemical applications.

Another aspect of the present disclosure relates to an advantageous oil/gas and/or petrochemical ferrous or non-ferrous material component comprising two or more segments of ferrous or non-ferrous material components, friction stir weldments bonding adjacent segments of said components together, and laser shock peened surfaces having compressive residual stress surrounding the friction stir weldments.

Another aspect of the present disclosure relates to an advantageous oil/gas and/or petrochemical ferrous or non-ferrous material component comprising two or more segments of ferrous or non-ferrous material components, fusion weldments bonding adjacent segments of the components together, and laser shock peened surfaces having compressive residual stress surrounding the fusion weldments.

A further aspect of the present disclosure relates to an advantageous oil/gas and/or petrochemical ferrous or non-ferrous material component comprising one or more segments of ferrous or non-ferrous material components, and at least one laser shock processed component region having compressive residual stress on the surface of the one or more segments of the components.

A further aspect of the present disclosure relates to an advantageous oil/gas and/or petrochemical ferrous or non-ferrous material component comprising two or more segments of ferrous or non-ferrous material components, a combination of friction and fusion weldments bonding adjacent segments of said components together, and laser shock peened surfaces having compressive residual stress surrounding the combination of friction and fusion weldments.

Numerous advantages result from the advantageous use of laser shock peening and processing in oil, gas and petrochemical applications disclosed herein.

For example, in exemplary embodiments of the present disclosure, the disclosed use of LSP in steel and corrosion resistant alloy structures for oil and gas exploration, producing, and petrochemical applications results in compressive residual stresses near the surface of the treated part.

In a further exemplary embodiment of the present disclosure, the disclosed use of LSP in steel and corrosion resistant alloy structures for oil and gas exploration, producing, and petrochemical applications results in decreased grain thickness near the surface of the treated part relative to the bulk structure.

In a further exemplary embodiment of the present disclosure, the disclosed use of LSP in steel and corrosion resistant alloy structures for oil and gas exploration, producing, and petrochemical applications exhibits improved is fatigue life.

In a further exemplary embodiment of the present disclosure, the disclosed use of LSP in steel and corrosion resistant alloy structures for oil and gas exploration, producing, and petrochemical applications exhibits improved stress corrosion cracking resistance and environmental cracking resistance.

In a further exemplary embodiment of the present disclosure, the disclosed use of LSP in steel and corrosion resistant alloy structures for oil and gas exploration, producing, and petrochemical applications is effective in arresting pre-existing cracks.

In still a further exemplary embodiment of the present disclosure, the disclosed use of LSP in steel and corrosion resistant alloy structures for oil and gas exploration, producing, and petrochemical applications is effective in improving surface strength and surface hardening properties of the component.

In still a further exemplary embodiment of the present disclosure, the disclosed use of LSP in steel and corrosion resistant alloy structures for oil and gas exploration, producing, and petrochemical applications provides for lower grades of steel and corrosion resistant alloy materials to be qualified for service and/or a decrease in the structural thickness of treated regions.

These and other advantages, features and attributes of the use of laser shock peening and processing in oil and gas, and petrochemical applications will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 depicts a plot of compressive residual stresses as a function of depth after laser shock peening A656 grade 1 steel.

FIG. 2 depicts electron back scattered diffraction (EBSD) images of the microstructure of A656 steel (a) in the bulk region (unpeened) and (b) in the surface region (LSP treated).

FIG. 3 depicts the surface hardness of A656 steel before and after laser shock peening.

### DETAILED DESCRIPTION OF THE INVENTION

The present invention relates to the use of laser shock peening and processing in oil and gas exploration, producing, and petrochemical applications to improve the fatigue life, stress corrosion resistance, environmental cracking resistance and other properties of critical regions of steels and corrosion resistant alloys subjected to LSP treatment. The use of LSP in oil and gas exploration, producing, and petrochemical applications is distinguishable over the prior art in providing for conventional and friction stir welds, conventional and friction stir weld repairs, and treatment of critical regions of structures to yield improved properties and performance.

Laser shock peening or processing (LSP) is a mechanical process for treating of metallic materials where a high-energy, pulsed Neodymium-glass laser or yttrium aluminum garnet (YAG) crystal lasing rod, producing a very short pulse (from about 14 to 30 nanoseconds long) and a wavelength of about 1.06 μm with an energy per pulse of about 50 joules or more is directed from the laser through a chain of mirrors and lenses onto the surface of the part being treated. The surface of the metal part to be treated via LSP is first covered with two types of overlays. The first type of overlay on the surface of the part is an opaque overlay which is opaque to the laser beam. The opaque overlay may be, but is not limited to, a black coating, black paint, lead, aluminum, copper, and zinc. The type of opaque overlay may be used to tailor the shape and amplitude of the stress waves generated via LSP. Black paint is a particularly preferred opaque overlay. The second type of overlay is positioned on top of the opaque overlay, and may be any material that is transparent to the laser beam. The transparent overlay may be, but is not limited to, water, quartz and K7 glass. The surface area of the metal part to be treated with LSP is first coated with an opaque overlay, and then coated with the transparent overlay.

The laser beam is then directed onto the surface of the metal part and passes through the transparent overlay and strikes the opaque overlay where it immediately vaporizes a thin surface layer of the opaque overlay. The vapor or plasma generated from the opaque overlay then absorbs the incoming laser energy and rapidly heats and expands against the surface of the metal part to be treated and the transparent overlay. The transparent overlay functions to trap the thermally expanding vapor or plasma against the surface of the metal part to be treated, and results in the pressure rising to a much higher level than if the transparent overlay were not present. The trapped vapor or plasma builds to a pressure of up to 100,000 atmospheres. The sudden, high pressure against the surface of the metal part to be treated causes a shock wave to propagate into the metal part to be treated, and if the peak stress of the shock wave is above the dynamic yield strength of the material, the metal part yields and plastically deforms. As the stress wave propagates deeper into the metal, the peak stress of the wave decreases, but deformation of the metal continues until the peak stress falls below the dynamic yield strength of the metal. The shock wave generated by the laser and the coated metal part gives rise to compressive residual stresses at the surface of the metal part to be treated. The peak pressure generated during LSP treatment may be controlled by changing the power density of the laser beam. The peak pressure generated is proportional to the square root of the peak power density. The power density may range from 0.1 to 1×10⁴ depending upon the laser type, the treated material type and the depth of residual compressive stresses desired. LSP variable parameters include, but are not limited to, laser power density, spot size, and pulse width.

The shape of the spot treated on the metal part with the laser is generally round, but other shapes may be used to provide more efficient and effective processing conditions. The size of the area of the metal part to be treated with LSP with one pulse depends on number of material, laser and processing factors. The spot size may range from about 0.1 inch to about 1 inch in diameter. A typical spot size is generally from about 0.24 to about 0.35 inches in diameter. For metal parts that are about 0.5 inch in thickness or more, a single laser beam is directed onto the area of the metal part to be treated. For metal parts that are less than about 0.5 inch in thickness, in order to minimize the distortion of the part, the laser beam may be split into two beams of equal intensity, and these beams are used to strike opposite sides of the part simultaneously. Alternatively, thin sections of metal parts to be treated may be treated from one side only by using a back-up support for the side of the metal part not being treated.

The size of the area of the metal part to be treated depends on the part design and the service conditions. A metal part may require that only a small area be LSP treated and a single treated spot may be sufficient, for example around small oil, pin, or bolt holes, or at the root of a notch in the side of a thin section. In other cases, the metal part may require that a large area be LSP treated, for example around the circumference of a weld line joining two pipes or a weld line joining two shafts of deep water oil drill bit. In these cases, successive spots are overlapped until the circumference has been completely treated with LSP. Generally in treating areas larger than 1 centimeter (0.39 inches) in diameter, overlapping spots are needed.

The high-energy, pulsed Neodymium-glass laser for use in LSP may be positioned in close proximity to the work station where the metal parts to be treated are held and manipulated during LSP. In this case, a metal part is placed in a work station by loading it into a fixture, and then the part and fixture are moved into the proper position relative to the laser for LSP. After the metal part is positioned, the laser beam is directed into the work station, treating the desired spot on the metal part. The metal part is then either moved to the next position for the following spot to be treated or is removed from the work station and replaced with the next part to be treated. For high production rates, the steps of part pick-up, positioning, LSP, and part removal may be performed automatically, for example, via a robotic means. Alternatively, the laser may be transported to a field area, for example to pipeline or drilling platform areas where it may be used to treat the weld area after joining two pieces of pipeline or two pieces of drill shafts. In this case, the laser as opposed to the part to be treated may be repositioned following the LSP of a spot on the metal part. The circumference of a weld line in a pipeline or drill shaft may be treated via LSP by rotating the laser around the circumference of the circular part. Spot overlap is again utilized to provide for complete treatment of the weld area.

Laser peening treatment decreases the grain size thickness of the steel or corrosion resistant alloy near the surface region which induces a plastic strain relative to the bulk of the structure. The relative deformation of the surface region relative to the bulk region of the structure results in the generation of residual compressive stresses near the surface of the metal part. These residual stresses may be measured using x-ray diffraction techniques by measuring the spacing of the crystallographic lattice planes at the surface of the metal part relative to the unstressed crystal lattice of the same materials not subjected to LSP. Tension increases the spacing between the lattice planes and compression decreases the spacing between the lattice planes. The distribution of the residual stress below the metal surface is determined by successively removing a thin layer from the surface by electropolishing and then making x-ray measurements of the new surface. This incremental process is continued down to the maximum depth of interest, generally from about 0.020 to about 0.050 inches in depth. The actual depths of the LSP-induced compressive stresses will vary depending on the type and intensity of the laser processing conditions and the properties of the metal to be treated. With LSP, the residual compressive stresses are generally highest at the surface and decrease gradually with increasing depth below the surface.

The distribution of the residual stresses below the surface is generally much deeper for LSP than it is for shot peening. For comparison, the depth of compressive stresses induced with shot peening is generally less than 0.010 inches as opposed to 0.10 inches with LSP or an order of magnitude deeper with LSP.

Among the properties improved by the introduction of residual compressive stresses induced by LSP treatment include, but are not limited to, surface strength, fatigue life, fretting fatigue resistance, stress corrosion resistance, fatigue cracking resistance, environmental/corrosion cracking resistance, and surface hardness. In particular, the compressive residual stresses imparted by LSP prevent cracks from growing in metal structures, and hence improve the part's fatigue life. The compressive residual stresses are effective for reducing both fatigue cracks, environmental/corrosion cracks.

In one aspect of the present invention, LSP is useful in treating critical regions of ferrous materials, preferably for treating the critical regions of steels, and more preferably for treating high carbon steels having a CE equal to or greater than 0.48. Exemplary, but not limiting, plain carbon and alloy steels include, AISI 1010, 1020, 1040, 1080, 1095, A36, A516, A440, A633, A656, 4063, 4340, and 6150. Exemplary, but not limiting, high carbon steels include, AISI WI, SI, O1, A2, D2, M1, and API L80. In another aspect of the present invention, LSP is useful in treating ferrous corrosion resistant alloys, including but not limited to, stainless steel. Exemplary, but not limiting, stainless steels include, AISI 409, 446, 304, 316L, 410, 440A, 17-7PH and duplex s.s. In a further aspect of the present invention, LSP is useful in treating non-ferrous alloys, including but not limited to, titanium alloys and nickel alloys.

The critical regions of ferrous or non-ferrous material components include, but are not limited to, notch areas, areas surrounding bolt and pin holes, and at the root of a notch in the side of a thin sections.

In one embodiment of the present invention, LSP is used following conventional fusion welding methods in the weldment area to improve the aforementioned properties in the surface region of the weld, and hence improve the integrity and fatigue properties of the fusion weld.

In another embodiment of the present invention, LSP is used following friction stir welding methods in the weldment area to improve the aforementioned properties in the surface region of the weld, and hence improve the integrity and fatigue properties of the friction stir weld. FSW and LSP are used in combination to improve the service life of welded structures used in the oil and gas exploration, production, and refining industries, as well as the petrochemical industry. More particularly, FSW is used to make the weld followed by LSP being used to treat the weld area to reduce residual tensile stresses by creating residual compressive stresses near the surface of the friction stir weld area.

In another embodiment of the present invention, FSW in combination with LSP finds particular application in the welding of duplex stainless steels (duplex s.s. or DSS). Duplex s.s. derives its strength and corrosion resistance from a controlled balance of ferrite and austenite phases. The desired mixture phases in the bulk duplex s.s. is achieved by controlled hot working and/or a combination of cold working and annealing treatments. However, when the duplex s.s. is welded, the steel is heated to a very high temperature in a single phase ferrite region and cools to the duplex phase upon cooling to room temperature. In order to achieve the required balance of phases in the weldment at room temperature, the cooling rate of the weld has to be controlled. In practice, the cooling rate varies considerably affecting the phase balance and thus the resultant properties of the weldment. FSW of duplex s.s. provides a more consistent phase balance since the temperature of the joints may be more precisely controlled, and in particular may be done at a lower temperature in the two phase region, thus consistently yielding an acceptable microstructure and resultant properties. Following FSW of the duplex s.s. joint, the weldment is subjected to LSP to further enhance the aforementioned surface properties of the weld area.

In another embodiment of the present invention, LSP is used following friction stir repair methods of cracks in the repair area to improve the aforementioned properties in the surface region of the repair, and therefore improve the integrity and fatigue properties of the repair area.

In yet another embodiment of the present invention, LSP is used following a combination of friction stir and fusion welding methods in the weldment area to improve the aforementioned properties in the surface region of the weld, and hence improve the integrity and fatigue properties of the friction stir weld. More particularly, the steel is welded first using fusion welding or other conventional welding method known to have a high rate of productivity. Following high throughput fusion welding, the fusion line and HAZ of the welds may be processed by FSW. This reduces and potentially eliminates the HAZ and the tensile residual stresses in the near surface regions. The combination of fusion welding and friction stir welding enhances the integrity of the joint with regard to resistance to hydrogen embrittlement, fatigue, etc. without sacrificing productivity since bulk of the welding is performed by conventional methods and only the critical subsurface regions are processed by FSW. Finally, the weld area is processed by LSP to further enhance surface properties. Following the combination of fusion welding and friction stir welding of the weldment, it is subjected to LSP to further enhance the aforementioned surface properties of the weld area.

In one embodiment of the present invention, LSP is used to treat critical regions of ferrous and non-ferrous material structures used in the oil and gas exploration, production, and transport industries, as well as the petrochemical industry.

Exemplary, but non-limiting, structures in the oil and gas exploration, production, refining industry where LSP treatment is useful with conventional fusion welding or friction stir welding joining and repair techniques, are high strength pipeline weld areas, SCR and TTR weld areas, threaded components, oil drilling equipment weld areas (i.e. two sections of a deep water oil drill string), LNG and PLNG container weld areas, riser/casing joints, and well head equipment. In particular, LSP treatment reduces residual tensile stresses and softening in the HAZ for fusion welded high strength pipelines used to transport oil and gas. LSP improves the integrity of the weld or joint which correspondingly increases the toughness and fatigue resistance of the welded joints.

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

The following examples illustrate the present invention and the advantages thereto without limiting the scope thereof.

### EXAMPLES

### Example 1

### LSP Treatment of Steel

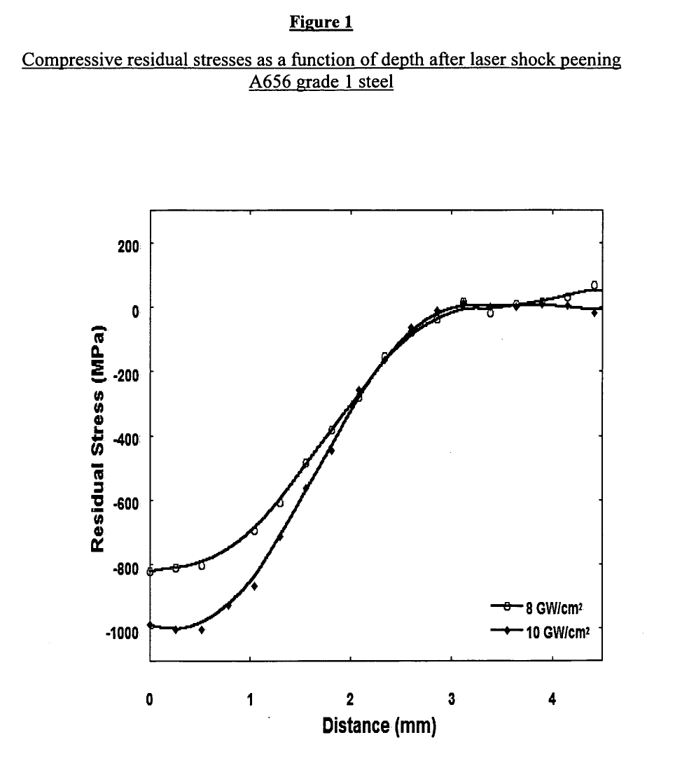

ASTM A656 grade 1 steel was treated with LSP to determine the residual compressive stresses generated below the surface. FIG. 1 is a plot of the compressive residual stresses induced by LSP treatment as a function of depth from the surface for A656 grade 1 steel for laser power densities of 8 and 10 GW/cm². Residual stresses were measured using the slitting method. The residual compressive stresses increase as a function of the laser power density utilized.

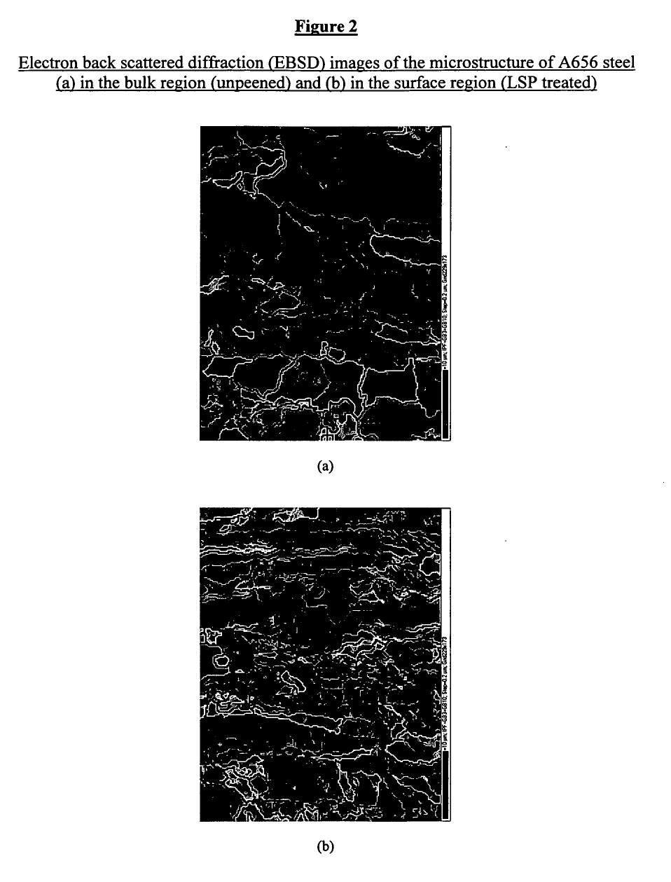

The A656 grain structure was subsequently measured using electron back scattered diffraction (EBSD). FIG. 2 shows the electron back scattered diffraction (EBSD) images of the microstructure of bulk A656 steel (a) in the bulk region (nonpeened) and (b) the surface region (after laser shock peening). From an examination of the microstructure of bulk A656 in figure (a), the average grain thickness was 3.4 micrometers. In contrast, the microstructure of the laser peened surface region (50 micrometers from the surface) of (b) depicts an average grain thickness of 1.8 micrometers. This shows that due to LSP treatment, the grains near the surface were deformed to a plastic strain of approximately 50%. The relative deformation of the surface layer with respect to the bulk causes the generation of residual compressive stresses at the surface of the structure.

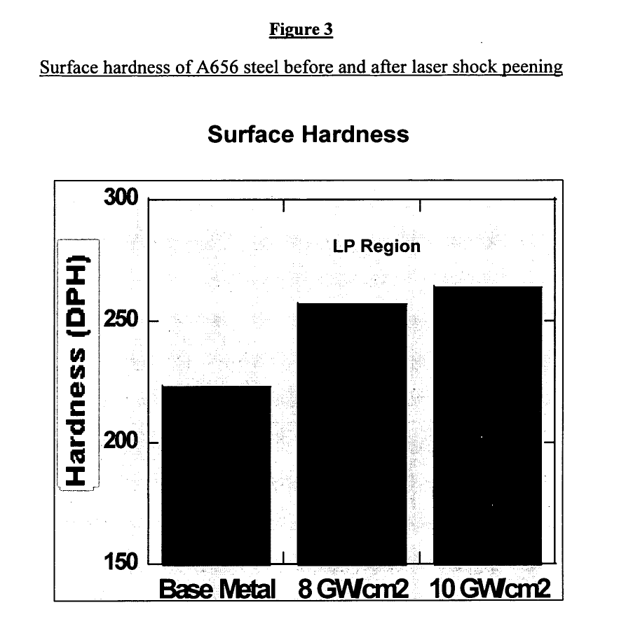

FIG. 3 depicts the surface hardness of A656 steel before and after laser shock peening. It shows that the surface region has work hardened and has a higher hardness with respect to the bulk due to LSP treatment.

What is claimed is:

1. A method of treating ferrous and non-ferrous components, comprising the following steps:
providing an opaque overlay on said component and a transparent overlay on top of said opaque overlay to form a coated component,
laser shock processing said coated component to produce a coated and treated ferrous component having at least one laser shock processed component region having compressive residual stress,
removing said opaque overlay and said transparent overlay from said coated and treated component to form a treated component, and
employing said treated component in oil/gas and/or petrochemical applications.

2. The method of claim 1 wherein said opaque overlay is black paint and wherein said transparent overlay is water.

3. The method of claim 1 wherein the laser shock processing conditions include laser power density, spot size, and pulse width.

4. The method of claim 1 wherein said at least one laser shock processed component region is an area surrounding a fusion weld.

5. The method of 1 wherein said at least one laser shock processed component region is an area surrounding a friction stir weld.

6. The method of 1 wherein said at least one laser shock processed component region is an area surrounding a weld formed from a combination of fusion welding and friction stir welding.

7. The method of claim 5 wherein the friction stir weld conditions include rotational speed, load, and travel speed of the friction stir weld tool used to create the weld.

8. The method of 1 wherein said at least one laser shock processed component region is an area surrounding a friction stir repair.

9. The method of claim 1 wherein said treated component employed in oil/gas and/or petrochemical applications is selected from the group consisting of high strength pipelines, steel catenary risers, top tension risers, threaded components, liquefied natural gas containers, pressurized liquefied natural gas containers, deep water oil drill strings, riser/casing joints, and well-head equipment.

10. The method of claim 1 wherein said treated component having at least one laser shock processed component region exhibits improvements in fatigue life, surface hardness, stress corrosion resistance, fatigue resistance, and environmental cracking resistance.

11. The method of claim 1 wherein said ferrous or non-ferrous component is a plain carbon steel, a high carbon steel having a CE equal to or greater than 0.48, a corrosion resistant alloy, a titanium alloy, a nickel alloy or duplex s.s.

12. An oil/gas and/or petrochemical ferrous or non-ferrous material component comprising:
two or more segments of ferrous or non-ferrous components,
friction stir weldments bonding adjacent segments of said components together, and
laser shock peened surfaces having compressive residual stress surrounding said friction stir weldments.

13. The component of claim 12 wherein said ferrous or non-ferrous component is a plain carbon steel, a high carbon steel having a CE equal to or greater than 0.48, a corrosion resistant alloy, a titanium alloy, a nickel alloy or duplex s.s.

14. The component of claim 12 wherein the friction stir weld conditions include rotational speed, load and travel speed of the friction stir weld tool used to effect the weld.

15. The component of claim 12 wherein the laser shock processing conditions include laser power density, spot size, and pulse width.

16. The component of claim 12 selected from the group consisting of high strength pipelines, steel catenary risers, top tension risers, threaded components, liquefied natural gas containers, pressurized liquefied natural gas containers, deep water oil drill strings, riser/casing joints, and well-head equipment.

17. The component of claim 12 wherein said component exhibits improvements in fatigue life, surface hardness, stress corrosion resistance, fatigue resistance, and environmental cracking resistance.

18. An oil/gas and/or petrochemical ferrous or non-ferrous material component comprising:
two or more segments of ferrous or non-ferrous material components, fusion weldments bonding adjacent segments of said components together, and
laser shock peened surfaces having compressive residual stress surrounding said fusion weldments.

19. The component of claim 18 wherein said ferrous or non-ferrous component is a plain carbon steel, a high carbon steel having a CE equal to or greater than 0.48, a corrosion resistant alloy, a titanium alloy, a nickel alloy or duplex s.s.

20. The component of claim 18 wherein the laser shock processing conditions include laser power density, spot size, and pulse width.

21. The component of claim 18 selected from the group consisting of high strength pipelines, steel catenary risers, top tension risers, threaded components, liquefied natural gas containers, pressurized liquefied natural gas containers, deep water oil drill strings, riser/casing joints, and well-head equipment.

22. The component of claim 18 wherein said component exhibits improvements in fatigue life, surface hardness, stress corrosion resistance, fatigue resistance, and environmental cracking resistance.

23. An oil/gas and/or petrochemical ferrous or non-ferrous material component comprising:
one or more segments of ferrous or non-ferrous components, and
at least one laser shock processed component region having compressive residual stress on the surface of said one or more segments of said components.

24. The component of claim 23 wherein said at least one laser shock processed component region is a friction stir repair area.

25. The component of claim 23 wherein said ferrous or non-ferrous component is a plain carbon steel, a high carbon steel having a CE equal to or greater than 0.48, a corrosion resistant alloy, a titanium alloy, a nickel alloy or duplex s.s.

26. The component of claim 23 wherein the laser shock processing conditions include laser power density, spot size, and pulse width.

27. The component of claim 23 selected from the group consisting of high strength pipelines, steel catenary risers, top tension risers, threaded components, liquefied natural gas containers, pressurized liquefied natural gas containers, deep water oil drill strings, riser/casing joints, and well-head equipment.

28. The component of claim 23 wherein said component exhibits improvements in fatigue life, surface hardness, stress corrosion resistance, fatigue resistance, and environmental cracking resistance.

29. An oil/gas and/or petrochemical ferrous or non-ferrous material component comprising:
two or more segments of ferrous or non-ferrous material components,
a combination of friction stir and fusion weldments bonding adjacent segments of said components together, and
laser shock peened surfaces having compressive residual stress surrounding said combination of friction and fusion weldments.

30. The component of claim 29 wherein said ferrous or non-ferrous component is a plain carbon steel, a high carbon steel having a CE equal to or greater than 0.48, a corrosion resistant alloy, a titanium alloy, a nickel alloy or duplex s.s.

31. The component of claim 29 wherein the friction stir weld conditions include rotational speed, load and travel speed of the friction stir weld tool used to effect the weld.

32. The component of claim 29 wherein the laser shock processing conditions include laser power density, spot size, and pulse width.

33. The component of claim 29 selected from the group consisting of high strength pipelines, steel catenary risers, top tension risers, threaded components, liquefied natural gas containers, pressurized liquefied natural gas containers, deep water oil drill strings, riser/casing joints, and well-head equipment.

34. The component of claim 29 wherein said component exhibits improvements in fatigue life, surface hardness, stress corrosion resistance, fatigue resistance, and environmental cracking resistance.
